(19) United States
(12) Patent Application Publication
(10) Pub. No.: US 2006/0179918 A1
(43) Pub. Date: Aug. 17, 2006

(54) Gas chromatograph and quartz crystal microbalance sensor apparatus

(75) Inventor: James Zt Liu, Rockford, IL (US)

Correspondence Address: Kris T. Fredrick;Honeywell International, Inc., 101 Columbia Rd., P.O.Box 2245, Morristown, NJ, 07962, US

(73) Assignee: Honeywell International

(21) Appl. No.: 11/058,550

(22) Filed: Feb. 15, 2005

(51) Int. Cl. G01N 29/02

(52) U.S. Cl. 73/23.4

(57) ABSTRACT

Quartz crystal microbalance (QCM) replaces the SAW device used in the gas chromatograph (GC) systems could result in better performance. The use of multiple vibration modes, variable vibration amplitude and overtones could make the sensor detector with self-temperature compensation capability, higher sensitivity and longer sensor life due to reduced aging rate.

### TECHNICAL FIELD

Embodiments are generally related to sensing devices and components thereof. Embodiments also relate to quartz crystal microbalance (QCM) and gas chromatograph (GC) devices and systems. Embodiments additionally relate to surface acoustic wave (SAW) and bulk acoustic wave (BAW) components and devices thereof.

### BACKGROUND OF THE INVENTION

Acoustic wave sensors are utilized in a variety of sensing applications, such as, for example, temperature and/or pressure sensing devices and systems. Acoustic wave devices have been in commercial use for over sixty years. Although the telecommunications industry is the largest user of acoustic wave devices, they are also used for chemical vapor detection. Acoustic wave sensors are so named because they use a mechanical, or acoustic, wave as the sensing mechanism. As the acoustic wave propagates through or on the surface of the material, any changes to the characteristics of the propagation path affect the velocity and/or amplitude of the wave.

Changes in velocity can be monitored by measuring the frequency or phase characteristics of the sensor and can then be correlated to the corresponding physical quantity or chemical quantity that is being measured. Virtually all acoustic wave devices and sensors utilize a piezoelectric crystal to generate the acoustic wave. Three mechanisms can contribute to acoustic wave sensor response, i.e., mass-loading, visco-elastic and acousto-electric effect. The mass-loading of chemicals alters the frequency, amplitude, and phase and Q value of the sensors. Most SAW chemical sensors, for example, rely on the mass sensitivity of the sensor in conjunction with a chemically selective coating that absorbs the vapors of interest resulting in an increased mass loading of the SAW sensor.

Examples of surface wave sensors include acoustic wave detection devices, which are utilized to detect the presence of substances, such as chemicals, or environmental conditions such as temperature and pressure. An acoustical or acoustic wave (e.g., SAW/BAW) device acting as a sensor can provide a highly sensitive detection mechanism due to the high sensitivity to surface loading and the low noise, which results from their intrinsic high Q factor. Surface acoustic wave devices are typically fabricated using photolithographic techniques with comb-like interdigital transducers placed on a piezoelectric material. Surface acoustic wave devices may have either a delay line or a resonator configuration.

One conventional type of SAW sensing device utilized in chemical sensing, particularly in explosive and chemical warfare agent detection applications is a chromatograph (GC) equipped with a surface acoustic wave (SAW) detector. Such a device is sometimes referred to as a “GC/SAW”. In a SAW-based GC system, the SAW resonator crystal is exposed to the exit gas of a GC capillary column by a carefully positioned and temperature-controlled nozzle. When condensable vapors entrained in the GC carrier gas impinge upon the active area between the resonator electrodes, a frequency shift occurs in proportion to the mass of the material condensing on the crystal surface. The frequency shift is dependent upon the properties (mass and the elastic constants) of the material being deposited, the temperature of the SAW crystal, and the chemical nature of the crystal surface.

A thermoelectric cooler can be utilized to maintain the SAW surface at sufficiently low temperatures to ensure a good trapping efficiency for explosive vapors. This cooler can be reversed to heat the crystal in order to clean the active surface (boil off adsorbed vapors). The temperature of the SAW crystal acts as a control over sensor specificity based upon the vapor pressure of the species being trapped. This feature is useful in distinguishing between relatively volatile materials and sticky explosive materials.

During a sampling sequence, for example, vapor samples are drawn through the GC inlet from a pre-concentrator and then pumped through a cryo-trap. The cryo-trap is a metal capillary tube held at a temperature low enough to trap explosive vapors, while allowing more volatile vapors to pass through. After passing through a second cryo-trap the sample can be injected into the GC column and separated in time by normal column operation for species identification. As the constituent vapors exit the column, they are collected and selectively trapped on the surface of the SAW crystal, where the frequency shift can be correlated to the material concentration.

One of the problems with conventional GC/SAW sensing devices is that the SAW components of the CG/SAW device are typically configured on or in association with a heater substrate. SAW sensitivity is generally controlled by selecting different substrate temperatures during chromatography. Thus, the SAW device operates at a very high frequency. Higher frequency means high cost, lower resolution, lower effective sensitivity, a higher aging rate and increased power.

It is therefore believed that a solution to these problems lies in designing a sensing component alternative to the SAW. One such component that has not been utilized to date in sensing applications, but which it is believed offers a greater efficiency and increased sensitivity, along with lower costs and lower power consumption is the quartz crystal microbalance (QCM).

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved sensing device.

It is another aspect of the present invention to provide for a gas chromatograph (GC) and quartz crystal microbalance (QCM) sensing device.

It is yet another aspect of the present invention to provide for improved surface acoustic wave (SAW) and bulk acoustic wave (BAW) components and devices thereof.

It is another aspect of the present invention to provide for a virtual acoustic wave sensor system that can function simultaneously according to a variety of vibration and harmonic modes, thereby providing the functionality of a plurality of sensors in a single sensing device or system.

The aforementioned aspects of the invention and other objectives and advantages can now be achieved as described herein. A sensor apparatus is disclosed, which includes a sensor comprising a gas chromatograph and a quartz crystal microbalance sensing element. A housing can also be provided for maintaining the gas chromatograph and the quartz crystal microbalance sensing element. The gas chromatograph and the quartz crystal microbalance sensing element generally utilize a vibration amplitude and overtones controlled quartz to absorb vapors exiting the gas chromatograph and wherein a sensitivity of the sensor is controlled by selecting the vibration modes, vibration amplitude, substrate temperature and overtones during chromatographic operations associated with the sensor in order to achieve high-precision and low frequency measurements thereof.

Additionally, an oscillator can be associated with the sensor. Sensor electronics are also generally associated with the sensor and the oscillator in order to control overtones and high amplitude fundamental frequencies associated with the sensor. The quartz crystal microbalance sensing element can be configured from SC-cut quartz crystal microbalance material. The SC-cut quartz crystal microbalance material permits resonator self-temperature and compensation via frequency measurement.

The SC-cut quartz crystal microbalance material can be thermal transient compensated and/or stress compensated, depending upon design considerations. The quartz crystal microbalance sensing element can also be configured as one or more resonators. The quartz crystal microbalance sensing element utilizes the vibration modes, vibration amplitude, substrate temperature and overtones controlled quartz to absorb vapors exiting a capillary region of the gas chromatograph. The capillary region can include walls thereof, wherein the capillary region is configured in a shape of a capillary column formed from the walls of the capillary region.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a QCM detector that can be implemented in accordance with an embodiment;

FIG. 2 illustrates the multiple modes that can exist in the quartz crystal micro-balance Detector, such as the detector depicted in FIG. 1;

FIG. 3 illustrates a BAW device with integrated heater/cooler for thermal adsorption/desorption curves, which can be implemented in accordance with an embodiment; and

FIG. 4 illustrates a detector system which can be implemented in accordance with one embodiment.

### DETAILED DESCRIPTION

The particular values and configurations discussed in these non-limiting examples can be varied and are cited merely to illustrate at least one embodiment and are not intended to limit the scope thereof.

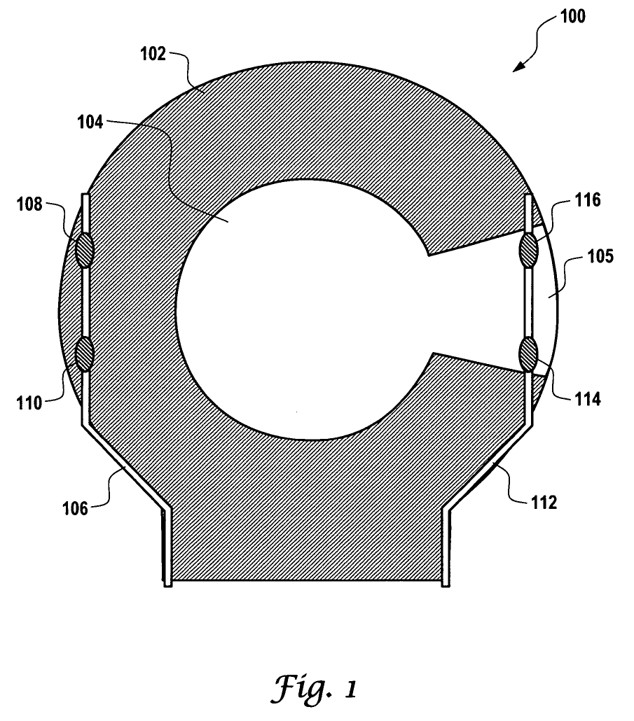

FIG. 1 illustrates a QCM detector 100 that can be implemented in accordance with an embodiment. QCM detector 100 generally utilizes a vibration amplitude/overtones controlled quartz material 104 to absorb vapors as they exit a GC capillary column of a GC device. Sensitivity of QCM detector 100 can be controlled by selecting the vibration modes, vibration amplitude, substrate temperature and/or overtones during chromatography.

The quartz material 104 is generally disposed within a circular region 102, which can be configured to function, for example, as an electrode in electrical communication with quartz material 104. Note that the quartz material 104 could be square, rectangular or circular in shape and includes an extending portion 105. There are two electrodes, one in the front side, and one in the back-side thereof. An electrical contact 106 can communicate with a back-side electrode at solder connections 108, 110. Similarly, electrical contact 112 can communicate with the front side electrode 104 at solider connections 114, 116.

Although a higher frequency resonator sensor can produce a larger frequency change per unit of measurand, it is also true that a higher frequency results in lower accuracy and in a lesser ability to resolve small changes in the measurand. The reasons are that higher frequency resonators of a given material and manufacturing technology are inherently noisier, and at least in the case of quartz resonators. Low frequency resonators can be constructed which possess a higher temperature stability than that of high frequency SAW resonators. Other disadvantages of utilizing higher frequencies include higher frequency resonators having a higher aging rate, and higher frequency digital electronics requiring more power.

The maximum Q allowed by the quartz material is rarely realized in conventional sensors. This is especially true for mass sensors where the added mass can produce significant damping. It is also important to note that the maximum Qf product is higher for BAW (i.e., QCM) devices than that of SAW devices, and is also dependent on crystal cut.

Because sensor capability need not be limited by frequency measurement capability, sensitivity expressed in Hz per unit of measurand is not a very useful measurement or indicator of sensor quality. Much more useful figures of merit include hysteresis divided by sensitivity and sy (1s) divided by sensitivity, where sensitivity can be calculated based on the normalized frequency change per unit of measurand. One indicator of a sensor's efficiency is a measure of the sensor's reproducibility, while another indicator is a measure of its resolution capability. When compared to such indicators, a “good” BAW (i.e., QCM) 5 MHz sensor, for example, will be found superior to that of a 500 MHz SAW sensor.

Dual modes of excitation of an SC-cut QCM allows for resonator self-temperature sensing and compensation by means of frequency measurement alone (i.e., without the use of a temperature sensor). In the case where the SC-cut is thermal transient compensated, the temperature and frequency characteristics depend only on temperature, not on the rate of temperature change. If the SC-cut is stress, compensated, certain types of stress (e.g., those due to electrodes) do not change frequency. An SC-cut resonator as utilized herein exhibits far fewer frequency versus temperature anomalies (e.g., activity dips). Additionally, SC-cut resonators of the same overtone possess a higher capacitance ratio, which means less sensitivity to circuit reactance change. SC-cut resonators are generally less sensitive to drive level change.

According to the embodiments disclosed herein, a high Q quartz crystal microbalance (QCM) can be utilized in place of a SAW component in sensing applications. The resulting sensor possesses a higher sensitivity than conventional SAW devices. Additionally, by not utilizing a heater, the QCM-based sensing device can employ overtones in order to obtain varying sensitivities. In this manner, a higher amplitude of vibration (e.g., mechanical energy and/or thermal energy) can be utilized to “shake away” condensations.

When compared to conventional devices on the basis of reproducibility and resolution capability, a “good” low frequency sensor is superior to a “good” high frequency device. Additionally, high-precision low frequency measurement is easier to achieve utilizing the sensing embodiments disclosed herein. The use of overtones, higher amplitude fundamental modes, and higher amplitude overtones are generally controlled and programmed through the use of the oscillator(s) and electronic components described herein.

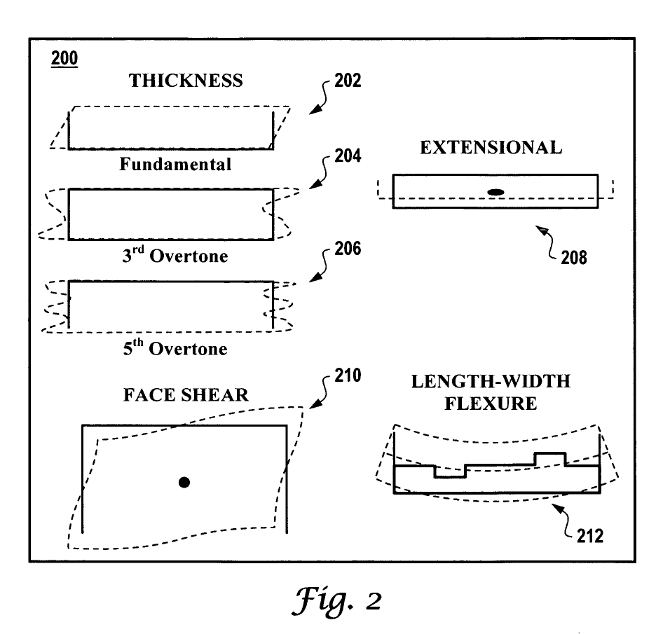

FIG. 2 illustrates the multiple modes 200 that can exist in the quartz crystal micro-balance detector, such as the detector 100 depicted in FIG. 1. As indicated in FIG. 2, example modes 200 can include one or more thickness modes, including fundamental 202, 3^{rd} overtone 204, and 5^{th} overtone 205 modes. An extensional mode 208 is also depicted in FIG. 2, along with a face shear mode 210 and a length-width fixture mode 212. It can be appreciated that one or more of such modes can be adapted for use in accordance with one or more embodiments.

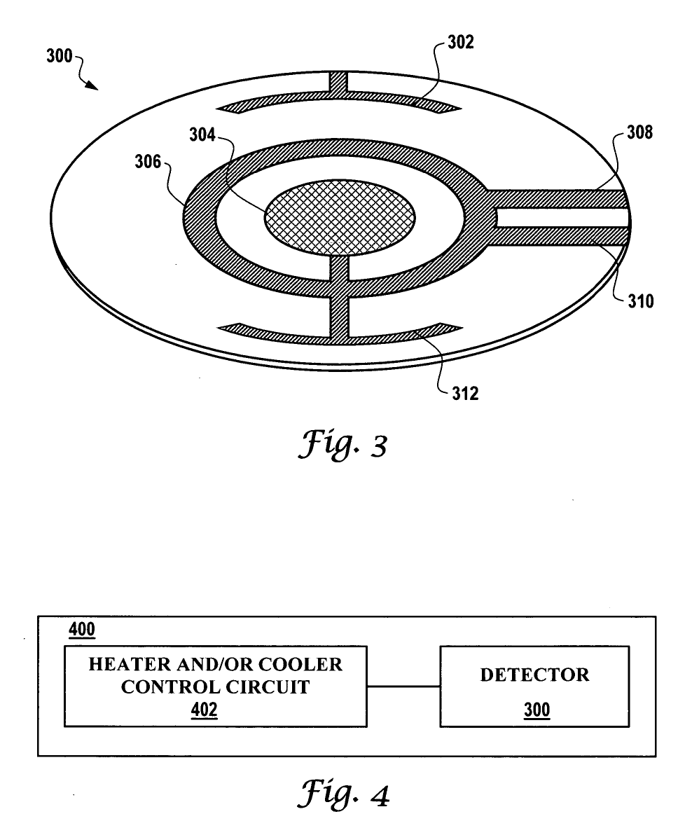

FIG. 3 illustrates a BAW device 300 with integrated heater and/or cooler for thermal adsorption/desorption curves in accordance with an embodiment. Device 300 can be implemented in accordance with the embodiments depicted in FIG. 1-3. Device 300 generally includes an arc portion 302, which is utilized for electrode connection of to a bottom electrode (not shown in FIG. 3), while an arc portion 312 is utilized for electrode connection to a top electrode 304. A ring portion 306 can be provided, which includes two electrical leads 308 and 310. The ring portion 306 with lead portions 308, 310 can be utilized for heater and/or cooler connections and/or contacts.

The ring portion 306 and the top electrode 304 are connected electrically. The top electrode 304 can be, for example, configured as front side electrode 104 depicted in FIG. 1. Thus, in some embodiments (although not all embodiments), the configuration depicted in FIG. 3 can be adapted for use with the detector 100 depicted in FIG. 1. When the BAW device 300 is configured in the manner indicated in FIG. 3, device 300 can function in the same manner as a SAW detector in a GC/SAW system.

Note that the quartz crystal microbalance sensing element described herein can be configured as an SC-cut quartz crystal microbalance that permits resonator self-temperature and compensation via frequency measurement. Such an SC-cut quartz crystal microbalance can also be thermal transient compensated and/or stress compensated. The quartz crystal microbalance sensing element disclosed herein can also be configured in the form of one or more resonators. Alternatively, the quartz crystal microbalance sensing element can be configured as an AT-cut quartz crystal microbalance.

FIG. 4 illustrates a detector system 400 which can be implemented in accordance with one embodiment. Note that the BAW device 300 illustrated in FIG. 3 can be adapted for use with system 400. Thus, system 400 includes detector 300. Note that in FIGS. 3-4, identical or similar parts are generally indicated by identical reference numerals. System 400 also includes a heater and/or cooler control circuit 402, which is associated with the sensor or detector 300, wherein the heater and cooler control circuit 402 controls a substrate temperature associated with the sensor or detector 300.

Note that the system 400 can be configured, for example, to include a housing (not shown in FIG. 4) for maintaining a gas chromatograph and a quartz crystal microbalance sensing element, wherein the gas chromatograph and the quartz crystal microbalance sensing element utilize vibration modes, vibration amplitudes and overtones controlled quartz to absorb vapors exiting the gas chromatograph and wherein a sensitivity of the sensor is controlled by selecting the vibration modes, amplitude and overtones during chromatographic operations associated with the sensor in order to achieve high-precision and low frequency measurements thereof.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A sensor apparatus, comprising:
a sensor comprising a gas chromatograph and a quartz crystal microbalance sensing element formed on a substrate; and
a housing for maintaining said gas chromatograph and said quartz crystal microbalance sensing element, wherein said gas chromatograph and said quartz crystal microbalance sensing element utilize a vibration mode, a vibration amplitude, a temperature of said substrate and at least one overtone controlled quartz to absorb vapors exiting said gas chromatograph and wherein a sensitivity of said sensor is controlled by selecting said vibration mode, said vibration amplitude, said temperature of said substrate, and said at least one overtone controlled quartz during chromatographic operations associated with said sensor in order to achieve high-precision and low frequency measurements thereof.

2. The apparatus of claim 1 further comprising:
at least one oscillator associated with said sensor; and
sensor electronics associated with said sensor and said at least one oscillator in order to control overtones, vibration mode and high amplitude fundamental frequencies associated with said sensor.

3. The apparatus of claim 1 further comprising:
at least one heater and cooler control circuit associated with said sensor; and
the heater and cooler control circuit associated with said sensor that could control the substrate temperature associated with said sensor.

4. The apparatus of claim 1 wherein said quartz crystal microbalance sensing element comprises an SC-cut quartz crystal microbalance.

5. The apparatus of claim 4 wherein said SC-cut quartz crystal microbalance permits resonator self-temperature and compensation via frequency measurement.

6. The apparatus of claim 4 wherein SC-cut quartz crystal microbalance is thermal transient compensated.

7. The apparatus of claim 4 wherein SC-cut quartz crystal microbalance is stress compensated.

8. The apparatus of claim 1 wherein said quartz crystal microbalance sensing element comprises at least one resonator.

9. The apparatus of claim 1 wherein said quartz crystal microbalance sensing element comprises an AT-cut quartz crystal microbalance.

10. The apparatus of claim 1 wherein said quartz crystal microbalance sensing element comprises a BT-cut quartz crystal microbalance.

11. The apparatus of claim 1 wherein said quartz crystal microbalance sensing element utilizes said vibration modes, vibration amplitude and overtones controlled quartz to absorb vapors exiting a capillary region of said gas chromatograph

12. The apparatus of claim 11 wherein said capillary region comprises walls thereof, wherein said capillary region is configured in a shape of a capillary column formed from said walls of said capillary region.

13. A sensor apparatus, comprising:
a sensor comprising a gas chromatograph and a quartz crystal microbalance sensing element;
an oscillator associated with said sensor;
sensor electronics associated with said sensor and said oscillator in order to control vibration modes, overtones and high amplitude fundamental frequencies associated with said sensor;
a heater and cooler control circuit associated with said sensor, wherein said heater and cooler control circuit controls a substrate temperature associated with said sensor; and
a housing for maintaining said gas chromatograph and said quartz crystal microbalance sensing element, wherein said gas chromatograph and said quartz crystal microbalance sensing element utilize at least one vibration mode, at least one vibration amplitude and overtones controlled quartz to absorb vapors exiting said gas chromatograph and wherein a sensitivity of said sensor is controlled by selecting said at least one vibration mode, said at least one vibration amplitude and said overtones controlled quarts during chromatographic operations associated with said sensor in order to achieve high-precision and low frequency measurements thereof.

14. The apparatus of claim 13 wherein said quartz crystal microbalance sensing element comprises an SC-cut quartz crystal microbalance.

15. The apparatus of claim 14 wherein said SC-cut quartz crystal microbalance permits resonator self-temperature and compensation via frequency measurement.

16. The apparatus of claim 14 wherein SC-cut quartz crystal microbalance is thermal transient compensated.

17. The apparatus of claim 14 wherein SC-cut quartz crystal microbalance material is stress compensated.

18. The apparatus of claim 14 wherein said quartz crystal microbalance sensing element comprises at least one resonator.

19. The apparatus of claim 13 wherein said quartz crystal microbalance sensing element comprises an AT-cut quartz crystal microbalance.

20. The apparatus of claim 12 wherein said quartz crystal microbalance sensing element comprises an BT-cut quartz crystal microbalance.

21. A virtual acoustic wave sensor system, comprising:
an acoustic wave sensor associated with an oscillator, wherein said acoustic wave sensor is excited by said oscillator in a fundamental mode comprising a plurality of successive overtones, wherein when acoustical vibration amplitudes thereof are varied, characteristics of said acoustic wave sensor are also modified, thereby permitting said acoustic wave sensor to function simultaneously according to a plurality of virtual acoustic wave modes.

22. The system of claim 21 wherein said virtual acoustic wave modes comprise at least one or more of the following modes: an amplitude mode, a temperature mode, and a vibration mode.

23. The system of claim 21 wherein said vibration mode comprises at least one of the following modes: shear-horizontal mode, flexural plate mode, amplitude plate mode, thickness-shear mode, or extensional mode.
